(19) United States
(12) Patent Application Publication
(10) Pub. No.: US 2025/0364170 A1
(43) Pub. Date: Nov. 27, 2025

(54) Inductor module with heat dissipation function and manufacturing method thereof

(71) Applicant: RICHTEK TECHNOLOGY CORP., Hsinchu County (TW)

(72) Inventors: Shih-Chieh Lin, Kaohsiung City (TW); Heng-Chi Huang, Hsinchu County (TW); YongZhong Hu, Hsinchu County (TW); Lung-Sheng Lin, Hsinchu County (TW)

(21) Appl. No.: 18/895,355

(22) Filed: Sep. 24, 2024

Related U.S. Application Data
(60) Provisional application No. 63/652,063, filed on May 27, 2024.

(30) Foreign Application Priority Data
Aug. 20, 2024 (TW) 113131264

(51) Int. Cl. H01F 27/08; H01F 27/24; H01F 27/28; H01F 41/02; H01F 41/04

(52) U.S. Cl. CPC H01F 27/08; H01F 27/24; H01F 27/28; H01F 41/0246; H01F 41/04

(57) ABSTRACT

An inductor module includes a magnetic material, at least one internal conductor and a thermal conductive frame. The at least one internal conductor is placed within the magnetic material. The thermal conductive frame is placed in the magnetic material and includes an upper structure, a lower structure and a connecting bar. The connecting bar connects the upper structure and the lower structure.

### CROSS REFERENCE TO RELATED APPLICATIONS

This application claims the benefit of U.S. Provisional Application No. 63/652,063, filed on May 27, 2024. The content of the application is incorporated herein by reference.

### BACKGROUND OF THE INVENTION

### 1. Field of the Invention

The invention relates to inductor, and in particular, to an inductor module with heat dissipation function and a manufacturing method thereof.

### 2. Description of the Prior Art

Smart power stage (SPS) module integrates Metal-Oxide-Semiconductor Field-Effect Transistor (MOSFET), driver chip, current sensor and temperature sensor, etc., and may provide high efficiency, high power density and high switching frequency in applications such as high-performance computing and telecommunications. Smart power stage modules are often combined with power modules composed of passive components such as capacitors and inductors. As the application wattage becomes larger, the number of power modules required also increases, so heat dissipation becomes a major focus, and in addition to the heat generated by the chip of the smart power stage module, the inductor also generates heat, so the heat dissipation of the inductor can't be ignored.

In the prior art, the heat of the inductor is dissipated through metal conduction. However, exposed metal may rust or corrode in the environment. With the high temperature and humidity of the environment, the efficiency of components may deteriorate or even fail to operate. Therefore, how to dissipate heat in inductor design while avoiding rust and corrosion is a problem to be solved.

### SUMMARY OF THE INVENTION

According to an embodiment of the invention, an inductor module includes a magnetic material, at least one internal conductor and a thermal conductive frame. The at least one internal conductor is positioned inside the magnetic material. The thermal conductive frame is positioned inside the magnetic material and includes an upper structure, a lower structure and a connecting bar. The connecting bar connects the upper structure and the lower structure.

According to another embodiment of the invention, an inductor module manufacturing method includes forming at least one internal conductor, processing a high thermal conductivity material to generate a thermal conductive frame, disposing the at least one internal conductor and the thermal conductive frame within a magnetic material, and heating and compressing the magnetic material to form an inductor module. The thermal conductive frame includes an upper structure, a lower structure and a connecting bar. The connecting bar connects the upper structure and the lower structure.

According to another embodiment of the invention, an inductor module manufacturing method includes forming at least one internal conductor, disposing the at least one internal conductor within a first magnetic material, heating and compressing the first magnetic material to form an internal inductor element, processing a high thermal conductivity material to generate a thermal conductive frame, disposing the internal inductor element and the thermal conductive frame within a second magnetic material, and heating and compressing the second magnetic material to form an inductor module. The thermal conductive frame includes an upper structure, a lower structure and a connecting bar. The connecting bar connects the upper structure and the lower structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an inductor module according to an embodiment of the present invention.

FIG. 2 is a perspective view of the inductor module in FIG. 1.

FIG. 3 is a schematic diagram of another inductor module according to an embodiment of the present invention.

FIG. 4 is a schematic diagram of another inductor module according to an embodiment of the present invention.

FIG. 5 is a schematic diagram of another inductor module according to an embodiment of the present invention.

FIG. 6 is a schematic diagram of another inductor module according to an embodiment of the present invention.

FIG. 7 is a flow chart of an inductor module manufacturing method according to an embodiment of the present invention.

FIG. 8 is another flow chart of an inductor module manufacturing method according to an embodiment of the present invention.

### DETAILED DESCRIPTION

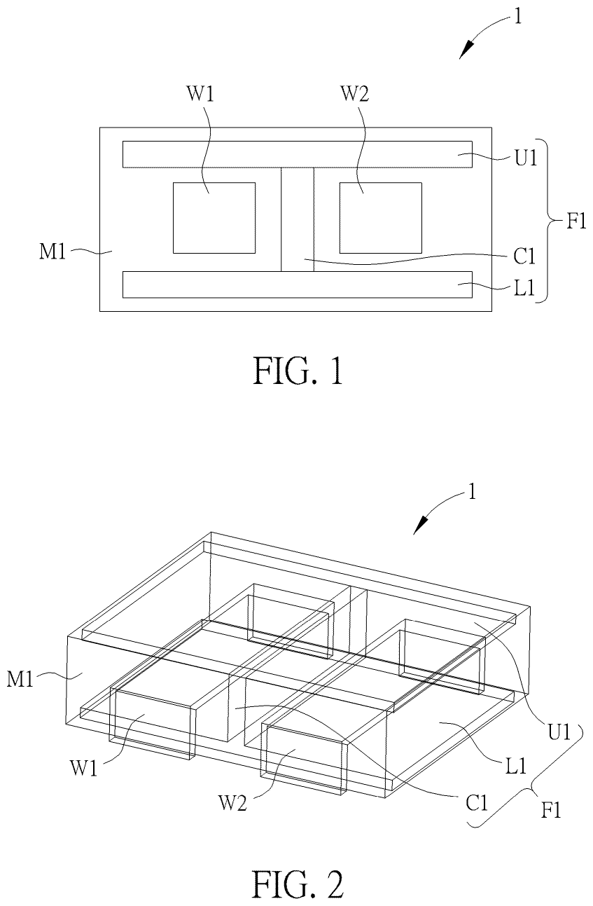

FIG. 1 is a schematic diagram of an inductor module 1 according to an embodiment of the present invention. The inductor module 1 may include a magnetic material M1, a thermal conductive frame F1 and internal conductors W1 and W2. The internal conductors W1 and W2 may be copper clips. The internal conductors W1 and W2 and the thermal conductive frame F1 are positioned inside the magnetic material M1 and covered by the magnetic material M1 to avoid corrosion caused by contact with air. The magnetic material M1 may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. The thermal conductive frame F1 includes an upper structure U1, a lower structure L1 and a connecting bar C1. The connecting bar C1 connects the upper structure U1 and the lower structure L1 for conducting heat. The material of the thermal conductive frame F1 is a high thermal conductivity material. The high thermal conductivity material may be a formable metal including steel, copper, silver, gold, aluminum, tungsten, zinc and/or stainless steel, or a non-metal such as aluminum nitride, silicon carbide and/or graphite. FIG. 2 is a perspective view of the inductor module 1 in FIG. 1. As shown in FIG. 2, the upper structure U1 may be positioned above the internal conductors W1 and W2, the lower structure L1 may be positioned below the internal conductors W1 and W2, and the upper structure U1 and the lower structure L1 may be parallel. In this embodiment, the width of the upper structure U1 and the lower structure L1 are equal, and the upper structure U1 and the lower structure L1 are connected by a connecting bar C1. In some other embodiments, the widths of the upper structure and the lower structure may not be equal, and the number and position of the connecting bars are not limited thereto. In some embodiments, the inductor module 1 may be coupled to an electronic component to dissipate heat from the electronic component. The electronic component may be a chip, an inductor, a capacitor and/or a resistor. In some embodiments, the inductor module 1 may also be coupled to a heat sink through a thermal interface material to implement better heat dissipation. The thermal interface material is a material positioned between the heat dissipation component and the heat-generating component to reduce the thermal contact resistance there between. The thermal interface material may be silicone grease, silicone gel, thermal paste, phase change material, phase change metal, heat dissipation pads, thermal conductive glue and/or solder materials, etc.

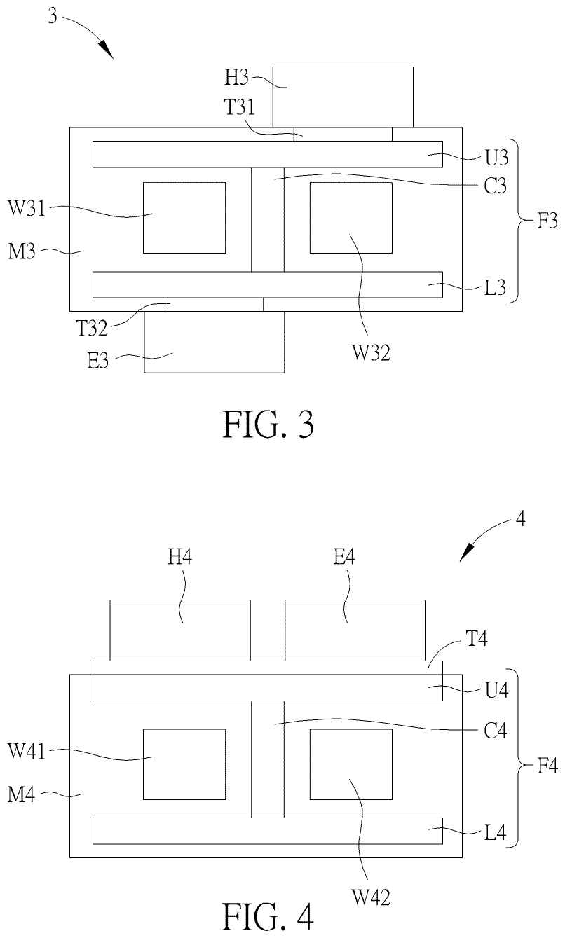

FIG. 3 is a schematic diagram of another inductor module 3 according to an embodiment of the present invention. The inductor module 3 may include a magnetic material M3, a thermal conductive frame F3 and internal conductors W31 and W32. The internal conductors W31 and W32 may be copper clips. The internal conductors W31 and W32 and the thermal conductive frame F3 are positioned inside the magnetic material M3 and covered by the magnetic material M3 to avoid corrosion caused by contact with air. The magnetic material M3 may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. The thermal conductive frame F3 includes an upper structure U3, a lower structure L3 and a connecting bar C3. The connecting bar C3 connects the upper structure U3 and the lower structure L3 for conducting heat. The differences between the inductor module 3 and the inductor module 1 is that the magnetic material M3 in the inductor module 3 may form an opening to partially expose the upper surface of the upper structure U3 and the lower surface of the lower structure L3. The exposed upper surface of the upper structure U3 may contact and be covered by the thermal interface material T31, and is coupled to the heat sink H3 through the opening with the thermal interface material T31. The exposed lower surface of the lower structure L3 may contact and be covered by the thermal interface material T32, and is coupled to the electronic component E3 through the opening with a thermal interface material T32. The electronic component E3 may be a chip, an inductor, a capacitor, a resistor and/or a substrate. The openings may be formed by drilling holes into the magnetic material in a back-end process. By forming openings to expose the upper surface of the upper structure and the lower surface of the lower structure and coupling to the heat sink and/or electronic components through the openings with the thermal interface material, the heat emitted by the electronic components may be more effectively conducted and/or the heat may be released through the heat sink to achieve better heat dissipation. Since the exposed upper surface of the upper structure and the exposed lower surface of the lower structure are both covered by the thermal interface materials, even if the exposed surfaces of the thermal conductive frame are not covered with magnetic materials, the exposed surfaces will not be exposed to air and cause corrosion. In this embodiment, the magnetic material M3 forms openings on the upper surface of the upper structure U3 and the lower surface of the lower structure L3 respectively to expose part of the upper surface of the upper structure U3 and part of the lower surface of the lower structure L3. In other embodiments, the magnetic material may form different numbers of openings on the upper surface of the upper structure and the lower surface of the lower structure respectively, and the number and size of the openings are not limited thereto.

FIG. 4 is a schematic diagram of another inductor module 4 according to an embodiment of the present invention. The inductor module 4 may include a magnetic material M4, a thermal conductive frame F4 and internal conductors W41 and W42. The internal conductors W41 and W42 may be copper clips. The internal conductors W41 and W42 and the thermal conductive frame F4 are positioned inside the magnetic material M4 and covered by the magnetic material M4 to avoid corrosion caused by contact with air. The magnetic material M4 may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. The thermal conductive frame F4 includes an upper structure U4, a lower structure L4 and a connecting bar C4. The connecting bar C4 connects the upper structure U4 and the lower structure L4 for conducting heat. The entire upper surface of the upper structure U4 may be exposed by grinding off the upper layer of the magnetic material M4 through a back-end process. The exposed upper surface of the upper structure U4 may contact and be covered by a layer of the thermal interface material T4, and is coupled to the electronic component E4 and the heat sink H4 through the thermal interface material T4 to conduct the heat generated by the electronic component E4 and release the heat through the heat sink H4. The electronic component may be a chip, an inductor, a capacitor, a resistor and/or a substrate. In other embodiments, the lower part of the magnetic material may also be ground away through a back-end process to expose the entire lower surface of the lower structure, and the exposed surface of the thermal conductive frame may be coupled to a different number of electronic components and/or heat sinks through thermal interface materials. Since the exposed upper surface of the upper structure and/or the exposed lower surface of the lower structure are covered by the thermal interface materials, even if the exposed surfaces of the thermal conductive frame are not covered with magnetic materials, the exposed surfaces will not be exposed to air and cause corrosion.

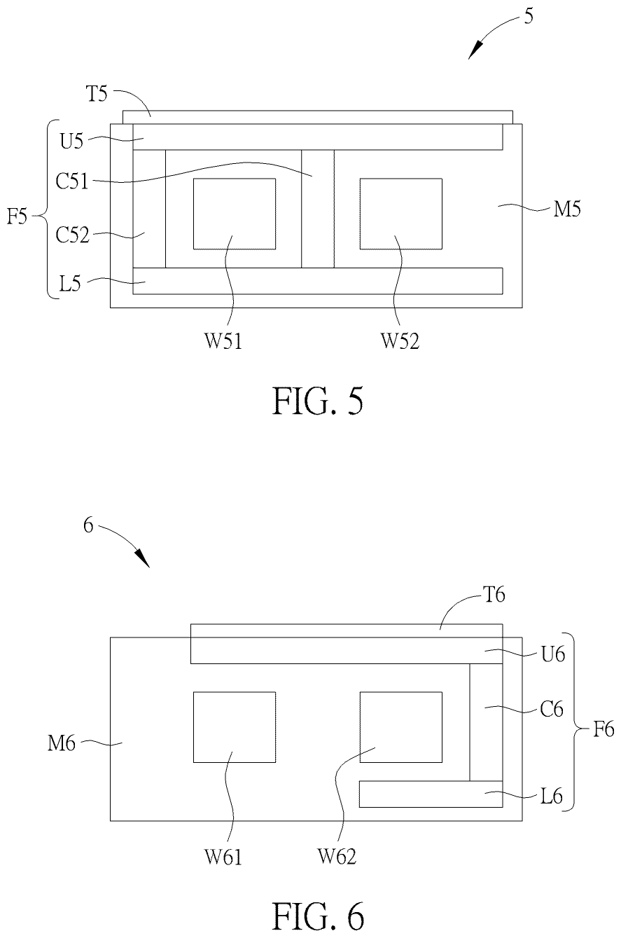

FIG. 5 is a schematic diagram of another inductor module 5 according to an embodiment of the present invention. The inductor module 5 may include a magnetic material M5, a thermal conductive frame F5 and internal conductors W51 and W52. The internal conductors W51 and W52 may be copper clips. The internal conductors W51 and W52 and the thermal conductive frame F5 are positioned inside the magnetic material M5 and covered by the magnetic material M5 to avoid corrosion caused by contact with air. The magnetic material M5 may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. The entire upper surface of the upper structure U5 may be exposed by grinding off the upper layer of the magnetic material M5 through a back-end process. The exposed upper surface of the upper structure U5 may contact and be covered by a layer of the thermal interface material T5, and may be coupled to an electronic component and/or a heat sink through the thermal interface material T5. The thermal conductive frame F5 includes an upper structure U5, a lower structure L5 and connecting bars C51 and C52. The connecting bars C51 and C52 connect the upper structure U5 and the lower structure L5 for conducting heat. Compared with the previous embodiment which only includes one connecting bar, the inductor module 5 includes two connecting bars C51 and C52 and can achieve better heat conduction. In other embodiments, the inductor module may include a different number of connecting bars, and the positions of the connecting bars are not limited thereto.

FIG. 6 is a schematic diagram of another inductor module 6 according to an embodiment of the present invention. The inductor module 6 may include a magnetic material M6, a thermal conductive frame F6 and internal conductors W61 and W62. The internal conductors W61 and W62 may be copper clips. The internal conductors W61 and W62 and the thermal conductive frame F6 are positioned inside the magnetic material M6 and covered by the magnetic material M6 to avoid corrosion caused by contact with air. The magnetic material M6 may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. The entire upper surface of the upper structure U6 may be exposed by grinding off the upper layer of the magnetic material M6 through a back-end process. The exposed upper surface of the upper structure U6 may contact and be covered by a layer of the thermal interface material T6, and may be coupled to an electronic component and/or a heat sink through the thermal interface material T6. The thermal conductive frame F6 includes an upper structure U6, a lower structure L6 and connecting bar C6. The connecting bar C6 connects the upper structure U6 and the lower structure L6 for conducting heat. As shown in FIG. 6, the length and width of the upper structure U6 and the lower structure L6 may be unequal, and the length and/or width of the upper structure U6 and the lower structure L6 may be respectively greater than, less than, or equal to the length and/or width of the connecting bar C6.

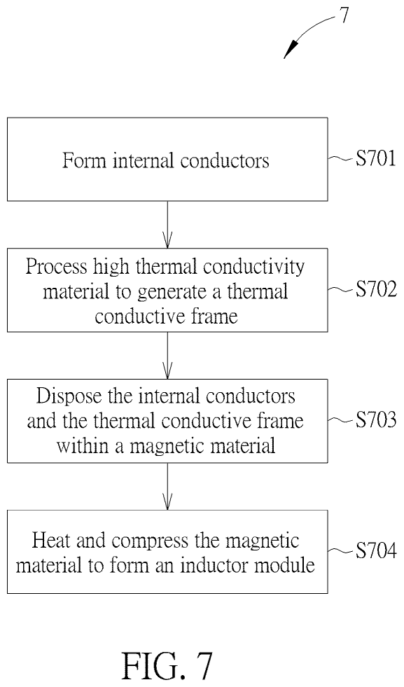

FIG. 7 is a flow chart of an inductor module manufacturing method 7 according to an embodiment of the present invention. The inductor module manufacturing method 7 comprises Steps S701 to S704 and is for manufacturing the inductor module. Any reasonable step change or adjustment is within the scope of the disclosure. Steps S701 to S704 are explained as follows:
Step S701: Form internal conductors;
Step S702: Process high thermal conductivity material to generate a thermal conductive frame;
Step S703: Dispose the internal conductors and the thermal conductive frame within a magnetic material;
Step S704: Heat and compress the magnetic material to form an inductor module.

The inductor module manufacturing method 7 is a monolithically formed method. In Step S701, the internal conductors are formed from a conductive material such as copper. In Step S702, process high thermal conductivity material to generate a thermal conductive frame including an upper structure, a lower structure and a connecting bar. The processing method may be stamping, casting, lathe washing, lathe, etching, etc. In Step S703, dispose the internal conductors in Step S701 and the thermal conductive frame in Step S702 within a mold, and add magnetic material in the mold to cover the internal conductors and the thermal conductive frame in the magnetic material. The magnetic material may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. Then in Step S704, the magnetic material surrounding the internal conductors and the thermal conductive frame is heated and compressed to form an inductor module.

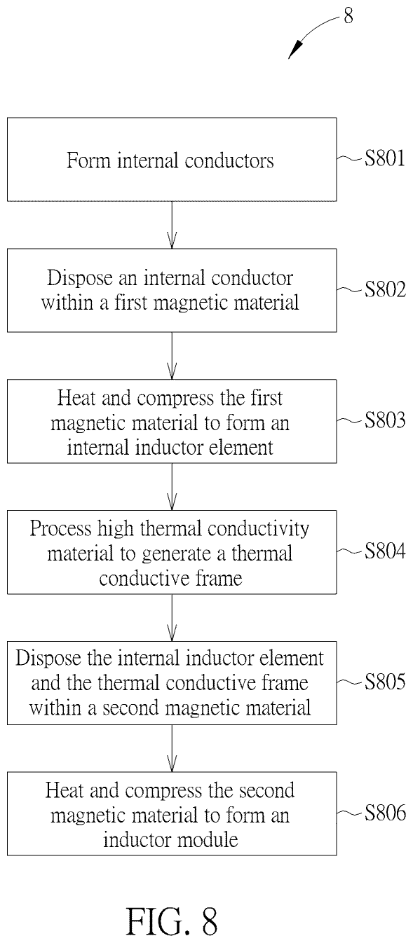

FIG. 8 is a flow chart of another inductor module manufacturing method 8 according to an embodiment of the present invention. The inductor module manufacturing method 8 comprises Steps S801 to S806 and is for manufacturing the inductor module. Any reasonable step change or adjustment is within the scope of the disclosure. Steps S801 to S806 are explained as follows:
Step S801: Form internal conductors;
Step S802: Dispose an internal conductor within a first magnetic material;
Step S803: Heat and compress the first magnetic material to form an internal inductor element;
Step S804: Process high thermal conductivity material to generate a thermal conductive frame;
Step S805: Dispose the internal inductor element and the thermal conductive frame within a second magnetic material;
Step S806: Heat and compress the second magnetic material to form an inductor module.

The inductor module manufacturing method 8 is a modularized method. In Step S801, the internal conductors are formed from a conductive material such as copper. In Step S802, dispose an internal conductor in Step S801 within a first mold, and add a first magnetic material in the first mold to cover the internal conductor in the first magnetic material. The first magnetic material may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. Then in Step S803, the first magnetic material surrounding the internal conductor is heated and compressed to form an internal inductor element. An internal inductor element includes an internal conductor, so if the inductor module includes multiple internal conductors, Steps S802 and S803 may be repeated to form multiple internal inductor elements. In Step S804, process high thermal conductivity material to generate a thermal conductive frame including an upper structure, a lower structure and a connecting bar. The processing method may be stamping, casting, lathe washing, lathe, etching, etc. In Step S805, dispose the internal inductor elements in Step S803 and the thermal conductive frame in Step S804 within a second mold, and add the second magnetic material in the second mold to cover the internal inductor elements and the thermal conductive frame in the second magnetic material. The second magnetic material may include ceramic magnet materials and/or iron alloy magnetic powder. The ceramic magnet materials may be nickel zinc ferrite, manganese zinc ferrite, magnesium copper zinc ferrite, etc. The iron alloy magnetic powder may be of soft magnetic material such as carbon-based iron powder, iron-nickel, iron-silicon, iron-silicon-aluminum, iron-silicon-chromium, amorphous alloy, etc. Then in Step S806, the second magnetic material surrounding the internal inductor elements and the thermal conductive frame is heated and compressed to form an inductor module. The differences between the inductor module manufacturing method 8 and the inductor module manufacturing method 7 is that in the inductor module manufacturing method 7, the internal conductors and the thermal conductive frame are heated and compressed together to form the inductor module. In the process of the inductor module manufacturing method 7, heating and compression are only performed once, and the mold does not need to be replaced. In the process of the inductor module manufacturing method 8, the internal conductors need to be heated and compressed first to form the internal inductor element, and then the internal inductor element and the thermal conductive frame are heated and compressed together to form the inductor module. Therefore, in the process of the inductor module manufacturing method 8, heating and compression are performed more than once, and the mold needs to be replaced. In some embodiments, the inductor module manufacturing method 8, which first forms the internal inductor component and then combines it with the thermal conductive frame, is easier to process than the inductor module manufacturing method 7, which is monolithically formed.

The inductor module of the present invention includes a thermal conductive frame positioned inside a magnetic material. The thermal conductive frame is covered by the magnetic material to avoid corrosion caused by contact with air. And in some embodiment, the magnetic material may form openings to expose surfaces of the thermal conductive frame and the thermal conductive frame may couple to the heat sink and/or electronic components through the openings with the thermal interface material, so the heat emitted by the electronic components may be more effectively conducted and/or the heat may be released through the heat sink to achieve better heat dissipation. Since the exposed surfaces of the thermal conductive frame are covered by the thermal interface materials, even if the exposed surfaces of the thermal conductive frame are not covered with magnetic materials, the exposed surfaces will not be exposed to air and cause corrosion. Through the inductor module of the present invention, better heat dissipation may be achieved while avoiding corrosion.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inductor module comprising:
a magnetic material;
at least one internal conductor positioned inside the magnetic material;
a thermal conductive frame positioned inside the magnetic material, comprising:
an upper structure,
a lower structure; and
a connecting bar connected to the upper structure and the lower structure.

2. The inductor module of claim 1, wherein:
the upper structure is positioned above the at least one internal conductor;
the lower structure is positioned below the at least one internal conductor; and
the upper structure is parallel to the lower structure.

3. The inductor module of claim 1, wherein the upper structure, the lower structure and the connecting part are made of a high thermal conductivity material.

4. The inductor module of claim 3, wherein the high thermal conductivity material comprises steel, copper, silver, gold, aluminum, tungsten, zinc, stainless steel, aluminum nitride, silicon carbide and/or graphite.

5. The inductor module of claim 1, wherein the inductor module is coupled to an electronic component.

6. The inductor module of claim 5, wherein the electronic component is a chip, an inductor, a capacitor and/or a resistor.

7. The inductor module of claim 1, wherein the inductor module is coupled to a heat sink.

8. The inductor module of claim 1, wherein the magnetic material forms at least an opening to expose an upper surface of the upper structure and/or a lower surface of the lower structure to contact a thermal interface material.

9. The inductor module of claim 1, wherein the magnetic material exposes an entire upper surface of the upper structure and/or an entire lower surface of the lower structure to contact a thermal interface material.

10. An inductor module manufacturing method comprising:
forming at least one internal conductor;
processing a high thermal conductivity material to generate a thermal conductive frame;
disposing the at least one internal conductor and the thermal conductive frame within a magnetic material; and
heating and compressing the magnetic material to form an inductor module;
wherein the thermal conductive frame comprises:
an upper structure;
a lower structure; and
a connecting bar connected to the upper structure and the lower structure.

11. The inductor module of claim 10, further comprising:
disposing the upper structure above the at least one internal conductor;
disposing the lower structure below the at least one internal conductor; and
the upper structure is disposed in parallel to the lower structure.

12. The inductor module of claim 10, further comprising coupling the inductor module to an electronic component and/or a heat sink.

13. The inductor module of claim 10, further comprising forming at least an opening on the magnetic material to expose an upper surface of the upper structure and/or a lower surface of the lower structure.

14. The inductor module of claim 13, further comprising coupling the inductor module with a heat sink, an electronic component and/or a substrate through the at least one opening with a thermal interface material.

15. An inductor module manufacturing method comprising:
forming at least one internal conductor;
disposing the at least one internal conductor within a first magnetic material;
heating and compressing the first magnetic material to form an internal inductor element;
processing a high thermal conductivity material to generate a thermal conductive frame;
disposing the internal inductor element and the thermal conductive frame within a second magnetic material; and
heating and compressing the second magnetic material to form an inductor module;
wherein the thermal conductive frame comprises:
an upper structure,
a lower structure; and
a connecting bar connected to the upper structure and the lower structure.

16. The inductor module of claim 15, further comprising:
disposing the upper structure above the at least one internal conductor;
disposing the lower structure below the at least one internal conductor; and
the upper structure is disposed in parallel to the lower structure.

17. The inductor module of claim 15, further comprising coupling the inductor module to an electronic component and/or a heat sink.

18. The inductor module of claim 15, further comprising forming at least an opening on the second magnetic material to expose an upper surface of the upper structure and/or a lower surface of the lower structure.

19. The inductor module of claim 18, further comprising filling the at least one opening with a thermal interface material to couple the inductor module with a heat sink, an electronic component and/or a substrate.

20. The inductor module of claim 18, further comprising forming a layer of thermal interface material on the at least one opening to couple the inductor module with a heat sink, an electronic component and/or a substrate.
